(19) United States
(12) Patent Application Publication
(10) Pub. No.: US 2015/0266184 A1
(43) Pub. Date: Sep. 24, 2015

(54) FORCE DETECTION DEVICE AND ROBOT

(71) Applicant: Seiko Epson Corporation, Tokyo (JP)

(72) Inventor: Yutaka ARAKAWA, Hara (JP)

(21) Appl. No.: 14/657,113

(22) Filed: Mar. 13, 2015

(30) Foreign Application Priority Data
Mar. 20, 2014 (JP) 2014-057663

(51) Int. Cl. B25J 9/16; G01L 1/16

(52) U.S. Cl. CPC B25J 9/1694; B25J 9/1633; G01L 1/16; Y10S 901/46; G05B 2219/39322; G05B 2219/39529

(57) ABSTRACT

A force detection device includes a first base unit, a second base unit that is arranged along a first direction with respect to the first base unit, a sealing member that is disposed in a section where the first base unit and the second base unit overlap each other when viewed in a second direction orthogonal to the first direction, and that forms a closed space with the first base unit and the second base unit, and a piezoelectric element that is disposed inside the closed space. The Young's modulus of the sealing member is higher than the Young's modulus of the first base unit and the Young's modulus of the second base unit.

### BACKGROUND

1. Technical Field

The present invention relates to a force detection device and a robot.

2. Related Art

In recent years, industrial robots have been progressively introduced to production facilities at a factory and the like in order to improve production efficiency. Such industrial robots representatively include a machine tool which carries out machining work for a base material such as an aluminum plate. In some cases, this machine tool has an incorporated force detection device for detecting a force acting on the base material when the machining work is carried out.

As an example of this force detection device, JP-A-2013-2945 discloses a force detection device (pressure sensor) for detecting applied pressure. The force detection device includes a first case, a second case arranged to oppose the first case, a sealing member (seal member) configured to have a fluorocarbon resin for sealing a gap between the first case and the second case, and a detection element disposed inside a pressure detection chamber defined by the first case, the second case, and the seal member. Then, JP-A-2013-2945 discloses that disposing the sealing member can improve air tightness in the pressure detection chamber and can prevent foreign materials from entering the pressure detection chamber.

However, in the force detection device disclosed in JP-A-2013-2945, the sealing member is arranged between the first case and the second case in a compression direction of the force detection device. For this reason, an output drift is greatly influenced due to thermal expansion of the sealing member. As a result, even though an external force is not applied, an unnecessary signal generated by the thermal expansion of the sealing member is output due to a temperature change in the external environment for using the force detection device, thereby causing a problem of degraded detection accuracy.

### SUMMARY

An advantage of some aspects of the invention is to provide a force detection device and a robot which have excellent detection accuracy by decreasing influence of a temperature drift.

The invention can be implemented as the following application examples.

### Application Example 1

A force detection device according to this application example of the invention includes a first base unit, a second base unit that is arranged along a first direction with respect to the first base unit, a sealing member that is disposed in a section where the first base unit and the second base unit overlap each other when viewed in a second direction orthogonal to the first direction, and that forms a closed space with the first base unit and the second base unit, and a piezoelectric element that is disposed inside the closed space. The Young's modulus of the sealing member is higher than the Young's modulus of the first base unit and the Young's modulus of the second base unit.

According to this configuration, it is possible to provide the force detection device which has excellent detection accuracy by decreasing influence of a temperature drift.

### Application Example 2

In the force detection device according to the application example of the invention, it is preferable that the sealing member is configured so that an area in contact with the first base unit is smaller than an area in contact with the second base unit.

According to this configuration, the first base unit and the second base unit can be easily assembled together, and a gap between the first base unit and the second base unit can be more reliably sealed with the sealing member.

### Application Example 3

In the force detection device according to the application example of the invention, it is preferable that the sealing member has a first section and a second section whose length along the first direction is shorter than the length of the first section.

According to this configuration, the first base unit and the second base unit can be easily assembled together, and a gap between the first base unit and the second base unit can be more reliably sealed with the sealing member.

### Application Example 4

In the force detection device according to the application example of the invention, it is preferable that a portion of the first base unit overlaps a portion of the second base unit over an entire circumference of the second base unit when viewed in the second direction.

According to this configuration, a gap between the first base unit and the second base unit can be more reliably sealed with the sealing member.

### Application Example 5

In the force detection device according to the application example of the invention, it is preferable that the sealing member has an annular shape.

According to this configuration, a gap between the first base unit and the second base unit can be more reliably sealed with the sealing member, and it is possible to prevent unnecessary stress generated due to thermal expansion of the sealing member from being detected.

### Application Example 6

In the force detection device according to the application example of the invention, it is preferable that the piezoelectric element includes a quartz crystal.

According to this configuration, the force detection device is less affected by temperature fluctuations, and thus, can accurately detect an external force.

### Application Example 7

In the force detection device according to the application example of the invention, it is preferable that the piezoelectric element is provided at multiple locations.

According to this configuration, it is possible to detect an external force applied to the force detection device, that is, six-axial forces (translational force components in α axis, β axis, and γ axis directions and rotational force components around the α axis, the β axis, and the γ axis).

### Application Example 8

A robot according to this application example of the invention includes an arm, an end effector that is disposed in the arm, and a force detection device that is disposed between the arm and the end effector, and that detects an external force applied to the end effector. The force detection device includes a first base unit, a second base unit that is arranged along a first direction with respect to the first base unit, a sealing member that is disposed in a section where the first base unit and the second base unit overlap each other when viewed in a second direction orthogonal to the first direction, and that forms a closed space with the first base unit and the second base unit, and a piezoelectric element that is disposed inside the closed space. The Young's modulus of the sealing member is higher than the Young's modulus of the first base unit and the Young's modulus of the second base unit.

According to this configuration, the force detection device included in the robot has excellent detection accuracy by decreasing influence of a temperature drift. Therefore, according to the robot, an external force can be accurately detected, thereby enabling the end effector to properly carry out work.

### BRIEF DESCRIPTION OF THE DRAWINGS

The invention will be described with reference to the accompanying drawings, wherein like numbers reference like elements.

FIG. 1 is a cross-sectional view illustrating a first embodiment of a force detection device according to the invention.

FIG. 2 is a plan view of the force detection device illustrated in FIG. 1.

FIG. 3 is a circuit diagram schematically illustrating the force detection device illustrated in FIG. 1.

FIG. 4 is a cross-sectional view schematically illustrating a charge output element included in the force detection device illustrated in FIG. 1.

FIG. 5 is a schematic view illustrating an operation state of a force detected by the charge output element of the force detection device illustrated in FIG. 1.

FIG. 6 is a view when viewed in a direction from an arrow A in FIG. 5.

FIG. 7 is an enlarged detailed view of a region [A] surrounded by a dashed line in FIG. 1.

FIGS. 8A and 8B are enlarged cross-sectional views of the force detection device used for examining an influence on detection sensitivity in a γ-axis direction which is exerted by thermal expansion of a sealing member.

FIGS. 9A to 9C are cross-sectional views illustrating another example of the sealing member included in the force detection device according to the embodiment of the invention.

FIG. 10 is a cross-sectional view illustrating a second embodiment of a force detection device according to the invention.

FIG. 11 is a view illustrating an example of a single-arm robot using the force detection device according to the invention.

### DESCRIPTION OF EXEMPLARY EMBODIMENTS

Hereinafter, preferred embodiments of the invention will be described in detail.

### 1. Force Detection Device

### First Embodiment

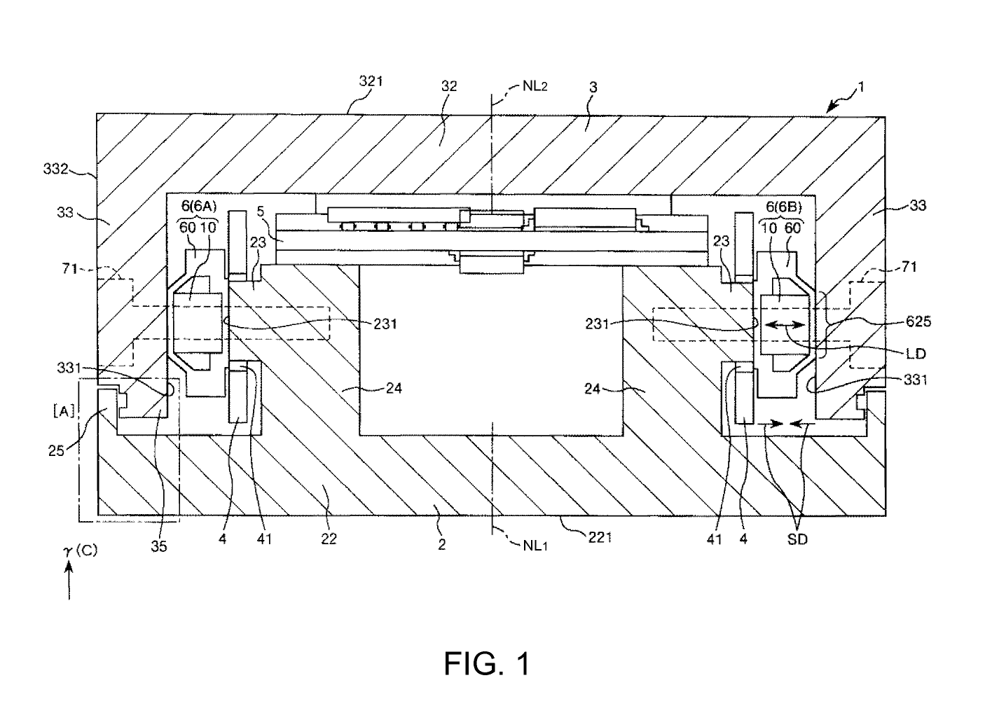

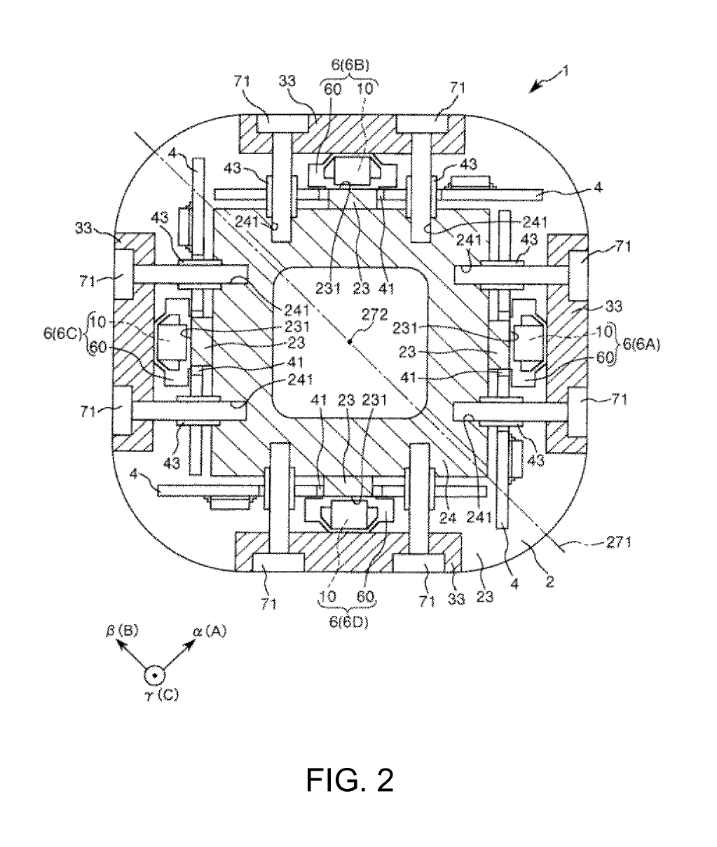

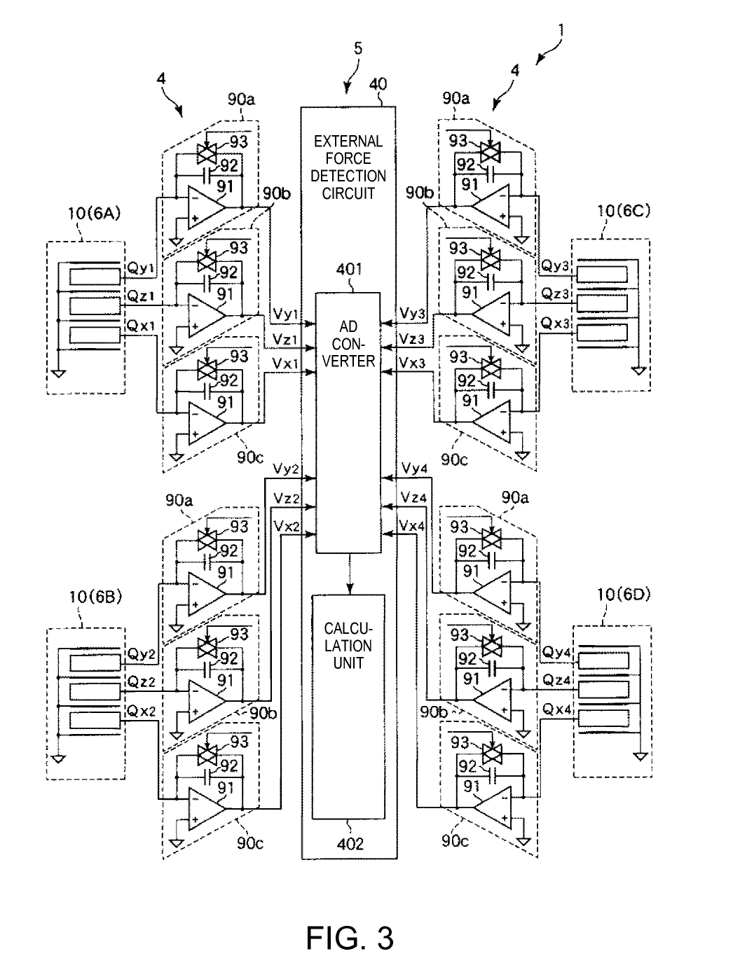

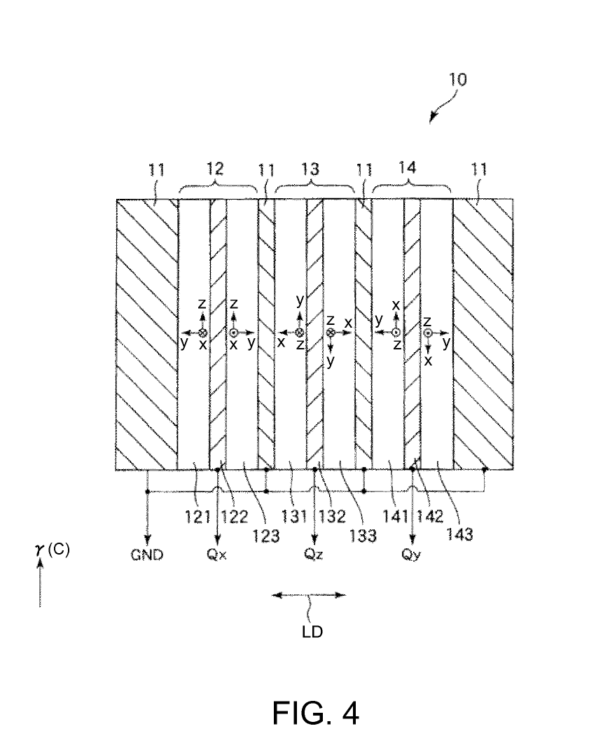

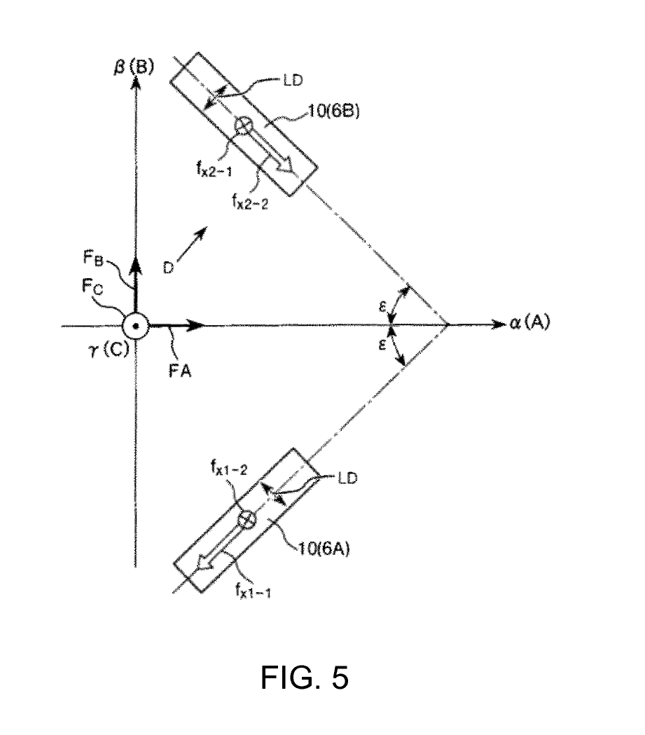

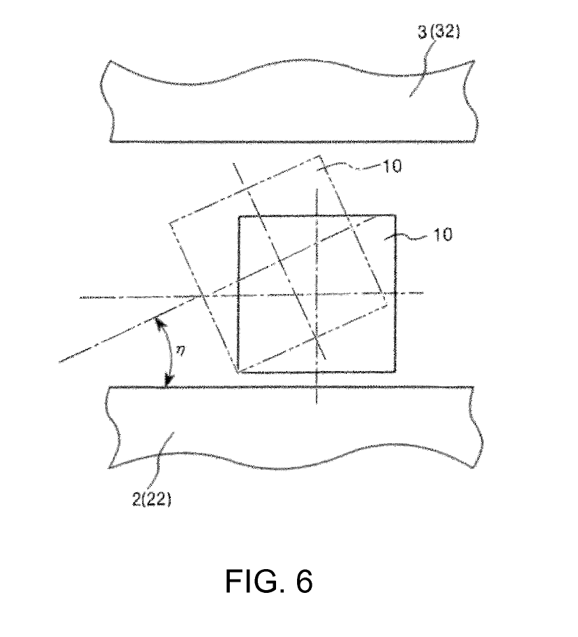

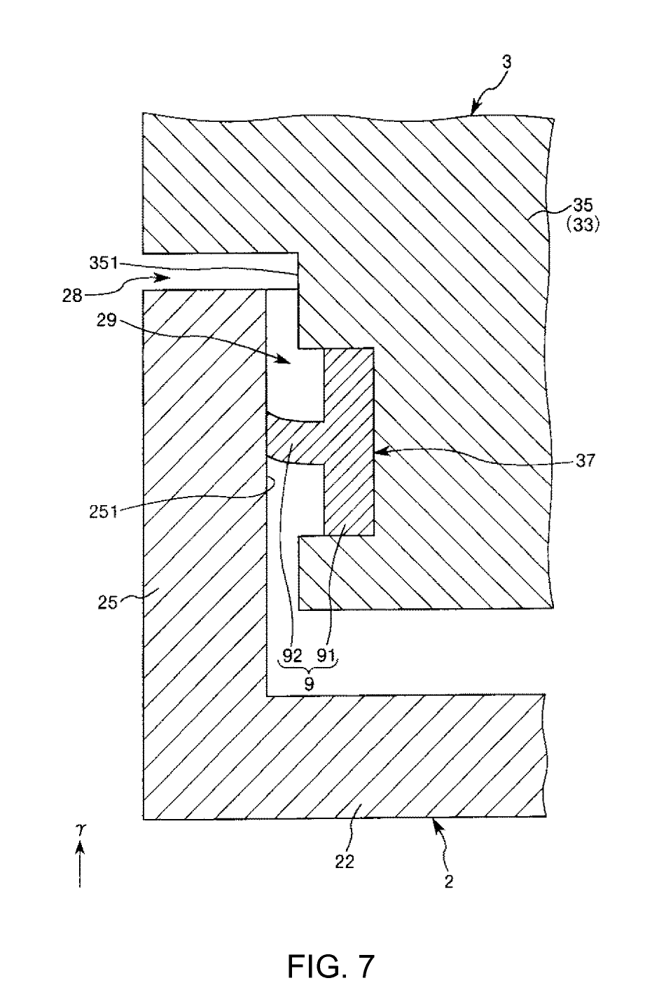

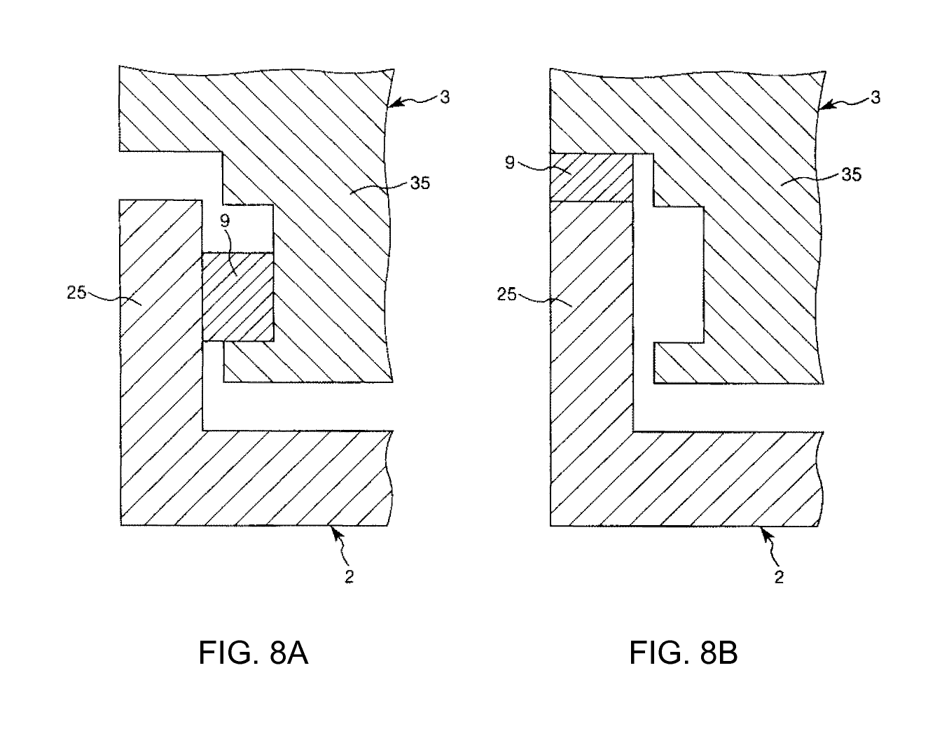

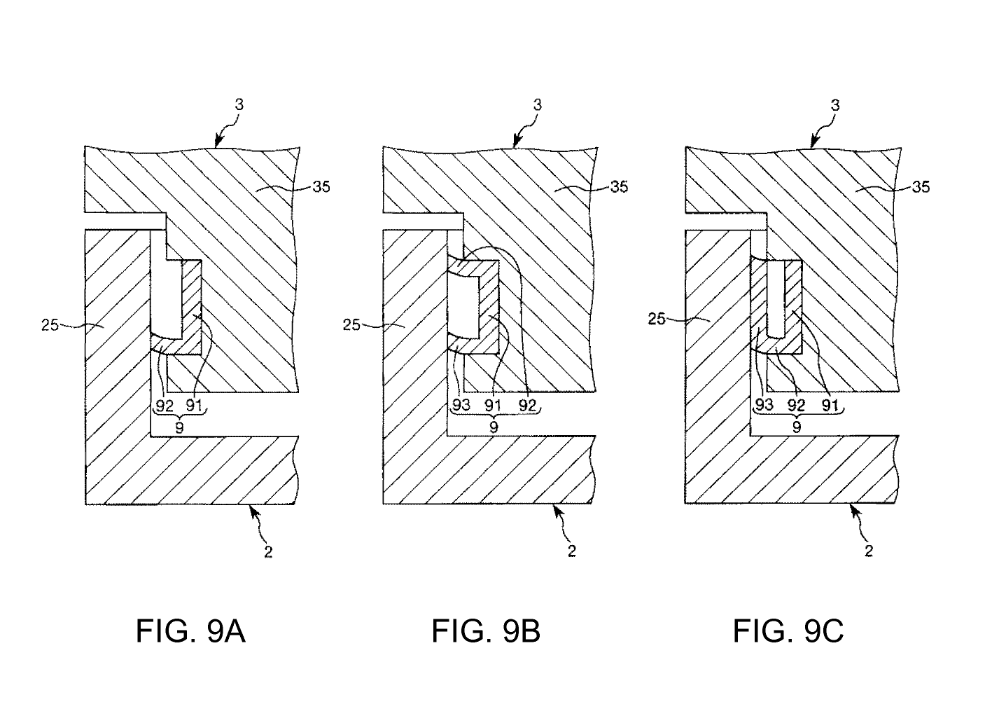

FIG. 1 is a cross-sectional view illustrating a first embodiment of a force detection device according to the invention. FIG. 2 is a plan view of the force detection device illustrated in FIG. 1. FIG. 3 is a circuit diagram schematically illustrating the force detection device illustrated in FIG. 1. FIG. 4 is a cross-sectional view schematically illustrating a charge output element included in the force detection device illustrated in FIG. 1. FIG. 5 is a schematic view illustrating an operation state of a force detected by the charge output element of the force detection device illustrated in FIG. 1. FIG. 6 is a view when viewed in a direction from an arrow A in FIG. 5. FIG. 7 is an enlarged detailed view of a region [A] surrounded by a dashed line in FIG. 1. FIGS. 8A and 8B are enlarged cross-sectional views of the force detection device used for examining an influence on detection sensitivity in a γ-axis direction which is exerted by thermal expansion of a sealing member. FIGS. 9A to 9C are cross-sectional views illustrating another example of the sealing member included in the force detection device according to the invention.

In the following description, the upper side in FIG. 1 is referred to as “up” or “upward”, and the lower side is referred to as “down” or “downward”.

FIGS. 1, 2, 4, and 5 illustrate an α axis, a β axis, and a γ axis as three axes which are orthogonal to one another. A direction in parallel with the α(A) axis is referred to as an “α(A) axis direction”, a direction in parallel with the β(B) axis is referred to as a “β(B) axis direction”, and a direction in parallel with the γ(C) axis is referred to as a “γ(C) axis direction”. In addition, a plane defined by the α axis and the β axis is referred to as an “αβ plane”, a plane defined by the β axis and the γ axis is referred to as an “βγ plane”, and a plane defined by the α axis and the γ axis is referred to as an “αγ plane”. In addition, a distal end side of the arrow in α axis, β axis, and γ axis directions is referred to as “+(positive) side”, and a proximal end side of the arrow is referred to as “− (negative) side”.

A force detection device 1 illustrated in FIG. 1 has a function of detecting an external force applied to the force detection device 1, that is, six-axial forces (translational force components in α axis, β axis, and γ axis directions and rotational force components around the α axis, the β axis, and the γ axis).

The force detection device 1 includes a first base unit (base unit) 2, a second base unit (base unit) 3 which is arranged to be separated from the first base unit 2 by leaving a predetermined distance therebetween and opposes the first base unit 2, an analog circuit board 4 which is accommodated (disposed) between the first base unit 2 and the second base unit 3, a digital circuit board 5 which is accommodated (disposed) between the first base unit 2 and the second base unit 3 and is electrically connected to the analog circuit board 4, four sensor devices 6 which are mounted on the analog circuit board 4 and have a charge output element (piezoelectric element) 10 for outputting a signal in response to an external force and a package (accommodation unit) 60 for accommodating the charge output element 10, and eight pressurization bolts (fixing member) 71.

Hereinafter, a configuration of each unit of the force detection device 1 will be described in detail.

In the following description, as illustrated in FIG. 2, among four sensor devices 6, a sensor device 6 located on the right side in FIG. 2 is referred to as a “sensor device 6A”, and the remaining sensor devices are referred to as a “sensor device 6B”, a “sensor device 6C”, and a “sensor device 6D” sequentially in a counterclockwise direction.

As illustrated in FIG. 1, the first base unit (base plate) 2 is configured so that an outer shape thereof is a plate shape and a planar shape thereof is a rounded rectangular shape. Without being limited to the illustrated shape, the planar shape of the first base unit 2 may be a circular shape or a polygonal shape other than the rectangular shape, for example.

A lower surface 221 of the first base unit 2 functions as an attachment surface (first attachment surface) to a robot (measurement target), when the force detection device 1 is used by being fixed to the robot.

The first base unit 2 has a bottom plate 22 and a wall 24 erected upward from the bottom plate 22.

The wall 24 has an “L-shape”, and convex portions 23 are respectively formed to protrude on two surfaces facing outward. A top surface 231 of the respective convex portions 23 is a plane perpendicular to the bottom plate 22. In addition, the convex portion 23 has a female screw 241 which is screwed to a pressurization bolt 71 (to be described later, refer to FIG. 2).

As illustrated in FIG. 1, the second base unit (cover plate) 3 is arranged so as to oppose the first base unit 2 by leaving a predetermined distance therebetween.

Similarly to the first base unit 2, the second base unit 3 is also configured so that the outer shape is a plate shape. It is preferable that the planar shape of the second base unit 3 is a shape corresponding to the planar shape of the first base unit 2. In the embodiment, similarly to the planar shape of the first base unit 2, the planar shape of the second base unit 3 is a corner-rounded rectangular shape. In addition, it is preferable that the second base unit 3 has a size enough to include the first base unit 2.

An upper surface 321 of the second base unit 3 functions as an attachment surface (second attachment surface) to an end effector (measurement target) mounted on the robot, when the force detection device 1 is used by being fixed to the robot, for example. In addition, the upper surface 321 of the second base unit 3 and the above-described lower surface 221 of the first base unit 2 are in parallel with each other in a natural state where an external force is not applied thereto.

The second base unit 3 has a top plate 32 and a side wall 33 which is formed at an edge portion of the top plate 32 and protrudes downward from the edge portion. An inner wall surface 331 of the side wall 33 is a plane perpendicular to the top plate 32. Then, the sensor devices 6 are disposed between the top surface 231 of the first base unit 2 and the inner wall surface 331 of the second base unit 3.

The first base unit 2 and the second base unit 3 are connected and fixed to each other by the pressurization bolt 71. As illustrated in FIG. 2, the number of the pressurization bolts 71 is eight (multiple), and every two pressurization bolts 71 among the eight pressurization bolts 71 are arranged on both sides of the respective sensor devices 6. The number of the pressurization bolts 71 for one sensor device 6 is not limited to two, but may be three or more, for example.

A configuration material of the pressurization bolt 71 is not particularly limited, but it is possible to use various resin materials or various metal materials, for example.

The first base unit 2 and the second base unit 3 which are connected to each other by the pressurization bolt 71 form an accommodation space for accommodating the sensor devices 6A to 6D, the analog circuit board 4, and the digital circuit board 5. The accommodation space has a circular shape or a corner-rounded square shape in cross section.

As illustrated in FIG. 1, the analog circuit board 4 connected to the sensor devices 6 is disposed between the first base unit 2 and the second base unit 3.

A hole 41 into which each of the convex portions 23 of the first base unit 2 is inserted is formed in a section where the sensor devices 6 (specifically, the charge output element 10) of the analog circuit board 4 are arranged. The hole 41 serves as a through-hole penetrating the analog circuit board 4.

As illustrated in FIG. 2, a through-hole through which each of the pressurization bolts 71 penetrates is disposed in the analog circuit board 4. A pipe 43 configured to have an insulation material such as a resin material is fixed to a portion (through-hole) through which the pressurization bolt 71 of the analog circuit board 4 penetrates by means of fitting, for example.

As illustrated in FIG. 3, the analog circuit board 4 connected to the sensor device 6A includes a conversion output circuit 90a which converts a charge Qy1 output from the charge output element 10 of the sensor device 6A into a voltage Vy1, a conversion output circuit 90b which converts a charge Qz1 output from the charge output element 10 into a voltage Vz1, and a conversion output circuit 90c which converts a charge Qx1 output from the charge output element 10 into a voltage Vx1.

The analog circuit board 4 connected to the sensor device 6B includes the conversion output circuit 90a which converts a charge Qy2 output from the charge output element 10 of the sensor device 6B into a voltage Vy2, the conversion output circuit 90b which converts a charge Qz2 output from the charge output element 10 into a voltage Vz2, and the conversion output circuit 90c which converts a charge Qx2 output from the charge output element 10 into a voltage Vx2.

The analog circuit board 4 connected to the sensor device 6C includes the conversion output circuit 90a which converts a charge Qy3 output from the charge output element 10 of the sensor device 6C into a voltage Vy3, the conversion output circuit 90b which converts a charge Qz3 output from the charge output element 10 into a voltage Vz3, and the conversion output circuit 90c which converts a charge Qx3 output from the charge output element 10 into a voltage Vx3.

The analog circuit board 4 connected to the sensor device 6D includes the conversion output circuit 90a which converts a charge Qy4 output from the charge output element 10 of the sensor device 6D into a voltage Vy4, the conversion output circuit 90b which converts a charge Qz4 output from the charge output element 10 into a voltage Vz4, and the conversion output circuit 90c which converts a charge Qx4 output from the charge output element 10 into a voltage Vx4.

As illustrated in FIG. 1, the digital circuit board 5 connected to and supported by the analog circuit board 4 is disposed at a position different from a position where the analog circuit board 4 is disposed on the first base unit 2, between the first base unit 2 and the second base unit 3. As illustrated in FIG. 3, the digital circuit board 5 includes an external force detection circuit 40 which has an AD converter 401 connected to the conversion output circuits (conversion circuits) 90a, 90b, and 90c, and a calculation unit (calculation circuit) 402 connected to the AD converter 401.

Respective configuration materials of the first base unit 2, the second base unit 3, a section other than each element and each wire of the analog circuit board 4, and a section other than each element and each wire of the digital circuit board 5 are not particularly limited, but it is possible to use various resin materials or various metal materials.

The first base unit 2 and the second base unit 3 are respectively configured to have a member whose outer shape is a plate shape. However, without being limited thereto, for example, one base unit may be configured to have the member having the plate shape, and the other base unit may be configured to have a member having a block shape.

Next, the sensor device 6 will be described in detail.

### Sensor Device

As illustrated in FIGS. 1 and 2, the sensor device 6A is pinched between the top surface 231 of one convex portion 23 among four convex portions 23 of the first base unit 2 and the inner wall surface 331 opposing the top surface 231. Similarly to the sensor device 6A, the sensor device 6B is pinched between the top surface 231 of one convex portion 23 which is different from the above-described convex portion 23 and the inner wall surface 331 opposing the top surface 231. In addition, the sensor device 6C is pinched between the top surface 231 of one convex portion 23 which is different from the above-described convex portion 23 and the inner wall surface 331 opposing the top surface 231. Furthermore, the sensor device 6D is pinched between the top surface 231 of one convex portion 23 which is different from the above-described convex portion 23 and the inner wall surface 331 opposing the top surface 231.

In the following description, a direction in which the respective sensor devices 6A to 6D are pinched between the first base unit 2 and the second base unit 3 is referred to as a “pinching direction SD”. In addition, a direction in which the sensor device 6A among the respective sensor devices 6A to 6D is pinched therebetween is referred to as a first pinching direction, a direction in which the sensor device 6B is pinched therebetween is referred to as a second pinching direction, a direction in which the sensor device 6C is pinched therebetween is referred to as a third pinching direction, and a direction in which the sensor device 6D is pinched therebetween is referred to as a fourth pinching direction.

In the embodiment, as illustrated in FIG. 1, the sensor device 6 is disposed on the second base unit 3 (side wall 33) side of the analog circuit board 4. However, the sensor device 6 may be disposed on the first base unit 2 side of the analog circuit board 4.

As illustrated in FIG. 2, the sensor device 6A and the sensor device 6B are arranged so as to be symmetric with the sensor device 6C and the sensor device 6D with regard to a central axis 271 extending along the β axis of the first base unit 2. That is, the sensor devices 6A to 6D are arranged at equal angles and intervals around the center 272 of the first base unit 2. It is possible to detect an external force without any bias by arranging the sensor devices 6A to 6D in this way.

Arrangement of the sensor devices 6A to 6D is not limited to the illustrated arrangement. However, it is preferable to arrange the sensor devices 6A to 6D at a position as far as possible from the center portion (center 272) of the second base unit 3 when viewed from the upper surface 321 of the second base unit 3. In this manner, it is possible to stably detect the external force applied to the force detection device 1.

In the embodiment, the sensor devices 6A to 6D are mounted in a state where all are oriented in the same direction. However, the orientations of the sensor devices 6A to 6D may be different from each other.

As illustrated in FIG. 1, the sensor device 6 arranged in this manner has the charge output element 10 and a package 60 for accommodating the charge output element 10. In addition, in the embodiment, the sensor devices 6A to 6D have the same configuration.

### Package

As illustrated in FIG. 2, a shape of the package 60 is not particularly limited. However, in the embodiment, the package 60 has a rectangular shape in a planar shape. For example, another shape of the package 60 includes other polygonal shapes such as a pentagonal shape, a circular shape, or an oval shape. In addition, for example, when the shape of the package 60 is the polygonal shape, a corner portion thereof may be rounded, or may be cut out obliquely.

As illustrated in FIG. 1, the package 60 has a concave member 61 having a concave portion and a lid body 62 bonded to the concave member 61.

The charge output element 10 is installed in the concave portion of the concave member 61, and the concave portion is sealed with the lid body 62. In this manner, the charge output element 10 is protected by the concave member 61 and the lid body 62, and it is possible to provide the force detection device 1 which is highly reliable. The upper surface of the charge output element 10 is in contact with the lid body 62.

The concave member 61 is arranged on the first base unit 2 side, and the lid body 62 is arranged on the second base unit 3 side. Then, the first base unit 2 and the second base unit 3 are fixed to each other by the pressurization bolt 71, thereby causing the concave member 61 and the lid body 62 to be pinched and pressurized between the top surface 231 of the first base unit 2 and the inner wall surface 331 of the second base unit 3 in the pinching direction SD. Furthermore, the charge output element 10 is also pinched and pressurized in the pinching direction SD between the concave member 61 and the lid body 62. That is, the charge output element 10 is pinched and pressurized between the top surface 231 of one convex portion 23 and the inner wall surface 331 of the second base unit 3 via the package 60.

The concave member 61 is configured so that a bottom surface thereof is a flat surface, is brought into contact with the top surface 231 of the first base unit 2, and is fixed to the analog circuit board 4. In addition, an end portion of the bottom surface of the concave member 61 has multiple terminals (not illustrated) which are electrically connected to the charge output element 10. The terminals are respectively and electrically connected to the analog circuit board 4, thereby causing the charge output element 10 and the analog circuit board 4 to be electrically connected to each other.

In the embodiment, the lid body 62 has a plate shape. A section between a central portion 625 and an outer peripheral portion 626 thereof is bent so that the central portion 625 protrudes toward the second base unit 3. The central portion 625 is in contact with the inner wall surface 331 of the second base unit 3. In addition, a shape of the central portion 625 is not particularly limited. However, in the embodiment, the shape is the same as that of the charge output element 10, that is, a rectangular shape. Both the upper surface 65 and the lower surface of the respective sensor devices 6 are flat surfaces.

A configuration material of the concave member 61 is not particularly limited. For example, it is possible to use an insulating material such as ceramics. In addition, a configuration material of the lid body 62 is not particularly limited. For example, it is possible to use a metal material such as stainless steel. The configuration material of the concave member 61 and the configuration material of the lid body 62 may be the same as each other, or may be different from each other.

### Charge Output Element

The charge output element 10 functions for outputting a charge in response to an external force applied to the force detection device 1, that is, an external force applied to at least one base unit between the first base unit 2 and the second base unit 3. Any base unit between the first base unit 2 and the second base unit 3 may serve as the base unit to which the external force is applied. However, in the embodiment, a case will be described where the second base unit 3 serves as the base unit to which the external force is applied.

The respective charge output elements 10 included in the sensor devices 6A to 6D have the same configuration, and thus, description will be made by concentrating on one charge output element 10.

As illustrated in FIG. 4, the charge output element 10 included in the sensor device 6 has a ground electrode layer 11, a first sensor 12, a second sensor 13, and a third sensor 14.

The first sensor 12 has a function of outputting a charge Qx (any one of charges Qx1, Qx2, Qx3, and Qx4) in response to the external force (shearing force). The second sensor 13 has a function of outputting a charge Qz (charges Qz1, Qz2, Qz3, and Qz4) in response to the external force (compressive force/tensile force). The third sensor 14 has a function of outputting a charge Qy (charges Qy1, Qy2, Qy3, and Qy4) in response to the external force (shearing force).

In the charge output element 10 included in the sensor device 6, the ground electrode layer 11 and the respective sensors 12, 13, and 14 are alternately stacked in parallel with one another. Hereinafter, a stacked direction thereof is referred to as a “stacked direction LD”. The stacked direction LD is a direction orthogonal to a normal line NL₂ of the upper surface 321 (or a normal line NL₂ of the lower surface 221). In addition, the stacked direction LD is in parallel with the pinching direction SD.

A shape of the charge output element 10 is not particularly limited. However, in the embodiment, the shape is a rectangular shape when viewed in a direction perpendicular to the inner wall surface 331 of each side wall 33. For example, another shape of each charge output element 10 includes the other polygonal shape such as a pentagonal shape, a circular shape, or an oval shape.

Hereinafter, the ground electrode layer 11, the first sensor 12, the second sensor 13, and the third sensor 14 will be described.

The ground electrode layer 11 is an electrode which is connected to the ground (reference potential point). A material for configuring the ground electrode layer 11 is not particularly limited. However, for example, it is preferable to use gold, titanium, aluminum, copper, iron or an alloy containing these materials. Among the materials, it is particularly preferable to use stainless steel which is an iron alloy. The ground electrode layer 11 configured to have the stainless steel has excellent durability and corrosion resistance.

The first sensor 12 has a function of outputting the charge Qx in response to the external force (shearing force) in a first detection direction which is orthogonal to the stacked direction LD (first pinching direction), that is, the same direction as the direction of the normal line NL₂ (normal line NL₂). That is, the first sensor 12 is configured so as to output a positive charge or a negative charge in response to the external force.

The first sensor 12 has a first piezoelectric layer (first detection plate) 121, a second piezoelectric layer (first detection plate) 123 disposed to oppose the first piezoelectric layer 121, and an output electrode layer 122 disposed between the first piezoelectric layer 121 and the second piezoelectric layer 123.

The first piezoelectric layer 121 is configured to have a Y-cut quartz crystal plate, and has an x axis, a y axis, and a z axis which are crystal axes orthogonal to one another. The y axis is an axis extending along a thickness direction of the first piezoelectric layer 121, the x axis is an axis extending along a depth direction of the paper surface in FIG. 4, and the z axis is an axis extending along a vertical direction in FIG. 4.

Hereinafter, description will be made in such a way that a distal end side of each illustrated arrow is referred to as “+ (positive)” and a proximal end side thereof is referred to as “− (negative)”. In addition, a direction in parallel with the x axis is referred to as an “x axis direction”, a direction in parallel with the y axis is referred to as a “y axis direction”, and a direction in parallel with the z axis is referred to as a “z axis direction”. The description is similarly applied to a second piezoelectric layer 123, a third piezoelectric layer 131, a fourth piezoelectric layer 133, a fifth piezoelectric layer 141, and a sixth piezoelectric layer 143 (which are to be described later).

The first piezoelectric layer 121 configured to have quartz crystal has excellent characteristics such as a wide dynamic range, high rigidity, high natural frequency, and high load bearing. In addition, the Y-cut quartz crystal plate generates a charge in response to the external force (shearing force) acting along a surface direction thereof.

Then, when the external force (shearing force) acting along a positive direction of the x axis is applied to the surface of the first piezoelectric layer 121, the charge is induced inside the first piezoelectric layer 121 by the piezoelectric effect. As a result, a positive charge gathers near the surface on the output electrode layer 122 side of the first piezoelectric layer 121, and a negative charge gathers near the surface on the ground electrode layer 11 side of the first piezoelectric layer 121. Similarly, when the external force acting along a negative direction of the x axis is applied to the surface of the first piezoelectric layer 121, the negative charge gathers near the surface on the output electrode layer 122 side of the first piezoelectric layer 121, and the positive charge gathers near the surface on the ground electrode layer 11 side of the first piezoelectric layer 121.

The second piezoelectric layer 123 is also configured to have the Y-cut quartz crystal plate, and has the x axis, the y axis, and the z axis which are the crystal axes orthogonal to one another. The y axis is an axis extending along the thickness direction of the second piezoelectric layer 123, the x axis is an axis extending along the depth direction of the paper surface in FIG. 4, and the z axis is an axis extending along the vertical direction in FIG. 4.

Similarly to the first piezoelectric layer 121, the second piezoelectric layer 123 configured to have the quartz crystal also has excellent characteristics such as the wide dynamic range, the high rigidity, the high natural frequency, and the high load bearing. The Y-cut quartz crystal plate generates the charge in response to the external force (shearing force) acting along the surface direction thereof.

Then, when the external force (shearing force) acting along the positive direction of the x axis is applied to the surface of the second piezoelectric layer 123, the charge is induced inside the second piezoelectric layer 123 by the piezoelectric effect. As a result, the positive charge gathers near the surface on the output electrode layer 122 side of the second piezoelectric layer 123, and the negative charge gathers near the surface on the ground electrode layer 11 side of the second piezoelectric layer 123. Similarly, when the external force acting along the negative direction of the x axis is applied to the surface of the second piezoelectric layer 123, the negative charge gathers near the surface on the output electrode layer 122 side of the second piezoelectric layer 123, and the positive charge gathers near the surface on the ground electrode layer 11 side of the second piezoelectric layer 123.

The output electrode layer 122 has a function of outputting the positive charge or the negative charge generated inside the first piezoelectric layer 121 and inside the second piezoelectric layer 123 as the charge Qx. As described above, when the external force acting along the positive direction of the x axis is applied to the surface of the first piezoelectric layer 121 or the surface of the second piezoelectric layer 123, the positive charge gathers near the output electrode layer 122. As a result, the positive charge Qx is output from the output electrode layer 122. In contrast, when the external force acting along the negative direction of the x axis is applied to the surface of the first piezoelectric layer 121 or the surface of the second piezoelectric layer 123, the negative charge gathers near the output electrode layer 122. As a result, the negative charge Qx is output from the output electrode layer 122.

A configuration in which the first sensor 12 has the first piezoelectric layer 121 and the second piezoelectric layer 123 can further increase the positive charge or the negative charge which gathers near the output electrode layer 122, as compared to a case where the first sensor 12 is configured to have only one between the first piezoelectric layer 121 and the second piezoelectric layer 123, and the output electrode layer 122. As a result, it is possible to increase the charge Qx output from the output electrode layer 122. This result is similarly applied to the second sensor 13 and the third sensor 14 (which are to be described later).

It is preferable that a size of the output electrode layer 122 is equal to or larger than a size of the first piezoelectric layer 121 and the second piezoelectric layer 123. If the output electrode layer 122 is smaller than the first piezoelectric layer 121 or the second piezoelectric layer 123, a portion of the first piezoelectric layer 121 or the second piezoelectric layer 123 does not come into contact with the output electrode layer 122. Therefore, in some cases, a portion of the charge generated in the first piezoelectric layer 121 or the second piezoelectric layer 123 cannot be output from the output electrode layer 122. As a result, the charge Qx output from the output electrode layer 122 is decreased. The result is similarly applied to output electrode layers 132 and 142 (to be described later).

The second sensor 13 has a function of outputting the charge Qz in response to the external force (compressive force/tensile force). That is, the second sensor 13 is configured so as to output the positive charge in response to the compressive force, and to output the negative charge in response to the tensile force.

The second sensor 13 has a third piezoelectric layer (third detection plate) 131, a fourth piezoelectric layer (third detection plate) 133 disposed to oppose the third piezoelectric layer 131, and the output electrode layer 132 disposed between the third piezoelectric layer 131 and the fourth piezoelectric layer 133.

The third piezoelectric layer 131 is configured to have an X-cut quartz crystal plate, and has the x axis, the y axis, and the z axis which are the crystal axes orthogonal to one another. The x axis is an axis extending along the thickness direction of the third piezoelectric layer 131, the y axis is an axis extending along the vertical direction in FIG. 4, and the z axis is an axis extending along the depth direction of the paper surface in FIG. 4.

Then, when the compressive force acting in parallel with the x axis is applied to the surface of the third piezoelectric layer 131, the charge is induced inside the third piezoelectric layer 131 by the piezoelectric effect. As a result, the positive charge gathers near the surface on the output electrode layer 132 side of the third piezoelectric layer 131, and the negative charge gathers near the surface on the ground electrode layer 11 side of the third piezoelectric layer 131. Similarly, when the tensile force acting in parallel with the x axis is applied to the surface of the third piezoelectric layer 131, the negative charge gathers near the surface on the output electrode layer 132 side of the third piezoelectric layer 131, and the positive charge gathers near the surface on the ground electrode layer 11 side of the third piezoelectric layer 131.

The fourth piezoelectric layer 133 is also configured to have the X-cut quartz crystal plate, and has the x axis, the y axis, and the z axis which are the crystal axes orthogonal to one another. The x axis is an axis extending along the thickness direction of the fourth piezoelectric layer 133, the y axis is an axis extending along the vertical direction in FIG. 4, and the z axis is an axis extending along the depth direction of the paper surface in FIG. 4.

Then, when the compressive force acting in parallel with the x axis is applied to the surface of the fourth piezoelectric layer 133, the charge is induced inside the fourth piezoelectric layer 133 by the piezoelectric effect. As a result, the positive charge gathers near the surface on the output electrode layer 132 side of the fourth piezoelectric layer 133, and the negative charge gathers near the surface on the ground electrode layer 11 side of the fourth piezoelectric layer 133. Similarly, when the tensile force acting in parallel with the x axis is applied to the surface of the fourth piezoelectric layer 133, the negative charge gathers near the surface on the output electrode layer 132 side of the fourth piezoelectric layer 133, and the positive charge gathers near the surface on the ground electrode layer 11 side of the fourth piezoelectric layer 133.

The output electrode layer 132 has a function of outputting the positive charge or the negative charge generated inside the third piezoelectric layer 131 and inside the fourth piezoelectric layer 133 as the charge Qz. As described above, when the compressive force acting in parallel with the x axis is applied to the surface of the third piezoelectric layer 131 or the surface of the fourth piezoelectric layer 133, the positive charge gathers near the output electrode layer 132. As a result, the positive charge Qz is output from the output electrode layer 132. In contrast, when the tensile force acting in parallel with the x axis is applied to the surface of the third piezoelectric layer 131 or the surface of the fourth piezoelectric layer 133, the negative charge gathers near the output electrode layer 132. As a result, the negative charge Qz is output from the output electrode layer 132.

The third sensor 14 has a function of outputting the charge Qx in response to the external force (shearing force) in a second detection direction which is orthogonal to the stacked direction LD (second pinching direction) and intersects the first detection direction of the external force acting when the first sensor 12 outputs the charge Qx. That is, the third sensor 14 is configured so as to output the positive charge or the negative charge in response to the external force.

The third sensor 14 has a fifth piezoelectric layer (second detection plate) 141, a sixth piezoelectric layer (second detection plate) 143 disposed to oppose the fifth piezoelectric layer 141, and the output electrode layer 142 disposed between the fifth piezoelectric layer 141 and the sixth piezoelectric layer 143.

The fifth piezoelectric layer 141 is configured to have the Y-cut quartz crystal plate, and has the x axis, the y axis, and the z axis which are the crystal axes orthogonal to one another. The y axis is an axis extending along the thickness direction of the fifth piezoelectric layer 141, the x axis is an axis extending along the vertical direction in FIG. 4, and the z axis is an axis extending along the depth direction of the paper surface in FIG. 4.

The fifth piezoelectric layer 141 configured to have the quartz crystal has the excellent characteristics such as the wide dynamic range, the high rigidity, the high natural frequency, and the high load bearing. In addition, the Y-cut quartz crystal plate generates the charge in response to the external force (shearing force) acting along the surface direction thereof.

Then, when the external force acting along the positive direction of the x axis is applied to the surface of the fifth piezoelectric layer 141, the charge is induced inside the fifth piezoelectric layer 141 by the piezoelectric effect. As a result, the positive charge gathers near the surface on the output electrode layer 142 side of the fifth piezoelectric layer 141, and the negative charge gathers near the surface on the ground electrode layer 11 side of the fifth piezoelectric layer 141. Similarly, when the external force acting along the negative direction of the x axis is applied to the surface of the fifth piezoelectric layer 141, the negative charge gathers near the surface on the output electrode layer 142 side of the fifth piezoelectric layer 141, and the positive charge gathers near the surface on the ground electrode layer 11 side of the fifth piezoelectric layer 141.

The sixth piezoelectric layer 143 is also configured to have the Y-cut quartz crystal plate, and has the x axis, the y axis, and the z axis which are the crystal axes orthogonal to one another. The y axis is an axis extending along the thickness direction of the sixth piezoelectric layer 143, the x axis is an axis extending along the vertical direction in FIG. 4, and the z axis is an axis extending along the depth direction of the paper surface in FIG. 4.

Similar to the fifth piezoelectric layer 141, the sixth piezoelectric layer 143 configured to have the quartz crystal also has the excellent characteristics such as the wide dynamic range, the high rigidity, the high natural frequency, and the high load bearing. The Y-cut quartz crystal plate generates the charge in response to the external force (shearing force) acting along the surface direction thereof.

Then, when the external force acting along the positive direction of the x axis is applied to the surface of the sixth piezoelectric layer 143, the charge is induced inside the sixth piezoelectric layer 143 by the piezoelectric effect. As a result, the positive charge gathers near the surface on the output electrode layer 142 side of the sixth piezoelectric layer 143, and the negative charge gathers near the surface on the ground electrode layer 11 side of the sixth piezoelectric layer 143. Similarly, when the external force acting along the negative direction of the x axis is applied to the surface of the sixth piezoelectric layer 143, the negative charge gathers near the surface on the output electrode layer 142 side of the sixth piezoelectric layer 143, and the positive charge gathers near the surface on the ground electrode layer 11 side of the sixth piezoelectric layer 143.

In the charge output element 10, when viewed in the stacked direction LD, each x axis of the first piezoelectric layer 121 and the second piezoelectric layer 123 intersects each x axis of the fifth piezoelectric layer 141 and the sixth piezoelectric layer 143. In addition, when viewed in the stacked direction LD, each z axis of the first piezoelectric layer 121 and the second piezoelectric layer 123 intersects each z axis of the fifth piezoelectric layer 141 and the sixth piezoelectric layer 143.

The output electrode layer 142 has a function of outputting the positive charge or the negative charge generated inside the fifth piezoelectric layer 141 and inside the sixth piezoelectric layer 143 as the charge Qy. As described above, when the external force acting along the positive direction of the x axis is applied to the surface of the fifth piezoelectric layer 141 or the surface of the sixth piezoelectric layer 143, the positive charge gathers near the output electrode layer 142. As a result, the positive charge Qy is output from the output electrode layer 142. In contrast, when the external force acting along the negative direction of the x axis is applied to the surface of the fifth piezoelectric layer 141 or the surface of the sixth piezoelectric layer 143, the negative charge gathers near the output electrode layer 142. As a result, the negative charge Qy is output from the output electrode layer 142.

As described above, in the charge output element 10, the first sensor 12, the second sensor 13, and the third sensor 14 are stacked on one another so that respective force detection directions of each sensor are orthogonal to one another. In this manner, each sensor can induce the charge in response to force components orthogonal to one another. Therefore, the charge output element 10 can output three charges Qx, Qy, and Qz respectively in response to each external force acting along the x axis, the y axis, and the z axis.

As described above, the charge output element 10 can output the charge Qz. However, when the force detection device 1 obtains each external force, it is preferable not to use the charge Qz. That is, it is preferable to use the force detection device 1 as a device for detecting the shearing force without detecting the compressive force or the tensile force. This can reduce noise components occurring due to a temperate change of the force detection device 1.

Here, as an example of the reason that it is preferable not to use the charge Qz in detecting the external force, a case will be described where the force detection device 1 is used for an industrial robot having an arm mounting an end effector. In this case, heat is transferred from a heat source such as a motor disposed in the arm or an end effector, thereby heating and causing the first base unit 2 or the second base unit 3 to be thermally expanded and deformed. This deformation causes pressurizing against the charge output element 10 to be changed from a predetermined value. The reason is that the change in pressurizing against the charge output element 10 disadvantageously contains the noise components occurring due to the temperature change of the force detection device 1 to such an extent as to significantly affect the charge Qz.

For this reason, the charge output element 10 detects only the charges Qx and Qy generated by the shearing fore being applied thereto without using the charge Qz generated by the compressive force or the tensile force being applied thereto. In this manner, it is possible to configure the charge output element 10 so as to be less likely to receive the influence resulting from the temperature fluctuations.

For example, the output charge Qz is used for pressurizing adjustment using the pressurization bolt 71.

In the embodiment, the above-described respective piezoelectric layers (first piezoelectric layer 121, second piezoelectric layer 123, third piezoelectric layer 131, fourth piezoelectric layer 133, fifth piezoelectric layer 141, and sixth piezoelectric layer 143) are all configured to employ the quartz crystal. However, the respective piezoelectric layers may be configured to employ piezoelectric materials other than the quartz crystal. The piezoelectric materials other than the quartz crystal include topaz, barium titanate, lead titanate, lead zirconate titanate (PZT: Pb (Zr, Ti) O₃), lithium niobate, and lithium tantalate. However, it is preferable to configure the respective piezoelectric layers by using the quartz crystal. The piezoelectric layer configured to have the quartz crystal has the excellent characteristics such as the wide dynamic range, the high rigidity, the high natural frequency, and the high load bearing.

As described above, the first base unit 2 and the second base unit 3 are fixed to each other by the pressurization bolt 71.

When the first base unit 2 and the second base unit 3 are fixed to each other by the pressurization bolt 71, in a state where each sensor device 6 is arranged between the top surface 231 and the inner wall surface 331, the pressurization bolt 71 is fitted to the convex portion 23 of the first base unit 2 from the side wall 33 side of the second base unit 3, and a male screw (not illustrated) of the pressurization bolt 71 is screwed into the female screw 241 formed in the first base unit 2. In this manner, in the charge output element 10, a predetermined magnitude of pressure, that is, pressurizing is applied to every package 60 for accommodating the charge output element 10 by the first base unit 2 and the second base unit 3.

The first base unit 2 and the second base unit 3 are fixed to each other by two pressurization bolts 71 so as to be mutually displaceable (movable) by a predetermined amount. If the first base unit 2 and the second base unit 3 are fixed so as to be mutually displaceable (movable) by the predetermined amount, when the shearing force acts on the charge output element 10 by the external force (shearing force) being applied to the force detection device 1, a friction force is reliably generated between the layers configuring the charge output element 10. Accordingly, it is possible to reliably detect the charge. In addition, a pressurizing direction of each pressurization bolt 71 is a direction in parallel with the stacked direction LD.

As illustrated in FIG. 5, in the charge output element 10 configured as described above, the stacked direction LD is tilted by a tilting angle ε with respect to an α axis. Specifically, the x axis of the first sensor 12 and the z axis of the third sensor 14 are tilted by the tilting angle ε with respect to the α axis. Therefore, in the embodiment, the α axis serves as a bisector which bisects an angle formed by the charge output element 10 of the sensor device 6A and the charge output element 10 of the sensor device 6B.

As illustrated in FIG. 6, when an angle formed by the x axis of the first sensor 12 and the bottom plate 22 of the first base unit 2 is set to η, each charge output element 10 is allowed to be tilted to such an extent that an angle η satisfies 0°≦η<90°. FIG. 6 is a view when viewed in a direction of an arrow D in FIG. 5, and the charge output element 10 when being tilted by the angle η with respect to the α axis (lower surface 221 of the bottom plate 22) is illustrated using a virtual line (two dot chain lines).

Next, a conversion output circuit 90a, a conversion output circuit 90b, and a conversion output circuit 90c which are included in each analog circuit board 4 will be described in detail.

### Conversion Output Circuit

As illustrated in FIG. 3, each conversion output circuit 90c converts any one (charge Qx) of the charges Qx1 to Qx4 into any one (representatively referred to as a “voltage Vx”) of voltages Vx1 to Vx4, each conversion output circuit 90b converts any one (charge Qz) of the charges Qz1 to Qz4 into any one (representatively referred to as a “voltage Vz”) of voltages Vz1 to Vz4, and each conversion output circuit 90a converts any one (charge Qy) of the charges Qy1 to Qy4 into any one (representatively referred to as a “voltage Vy”) of voltages Vy1 to Vy4.

Hereinafter, a configuration of the conversion output circuits 90a, 90b, and 90c will be described in detail. However, the respective conversion output circuits 90a, 90b, and 90c have the same configuration. Accordingly, hereinafter, the conversion output circuit 90c will be described representatively.

As illustrated in FIG. 3, the conversion output circuit 90c has a function of converting the charge Qx output from the charge output element 10 into the voltage Vx and outputting the voltage Vx. The conversion output circuit 90c has an operational amplifier 901, a capacitor 902, and a switching element 903. A first input terminal (minus input) of the operational amplifier 901 is connected to the output electrode layer 122 of the charge output element 10, and a second input terminal (plus input) of the operational amplifier 901 is connected to the ground (reference potential point). In addition, an output terminal of the operational amplifier 901 is connected to the external force detection circuit 40. The capacitor 902 is connected to a portion between the first input terminal and the output terminal of the operational amplifier 901. The switching element 903 is connected to a portion between the first input terminal and the output terminal of the operational amplifier 901, and is connected thereto in parallel with the capacitor 902. In addition, the switching element 903 is connected to a drive circuit (not illustrated). The switching element 903 performs a switching operation in accordance with on/off signals from the drive circuit.

When the switching element 903 is turned off, the charge Qx output from the charge output element 10 is accumulated in the capacitor 902 having electrostatic capacity Cl, and is output to the external force detection circuit 40 as the voltage Vx. Subsequently, when the switching element 903 is turned on, both terminals of the capacitor 902 are short-circuited. As a result, the charge Qx accumulated in the capacitor 902 is discharged to be zero Coulombs, and the voltage V output to the external force detection circuit 40 is zero V. Turning on the switching element 903 is referred to as resetting the conversion output circuit 90c. The voltage Vx output from the ideal conversion output circuit 90c is proportional to an accumulated amount of the charge Qx output from the charge output element 10.

For example, the switching element 903 is a Metal Oxide Semiconductor Field Effect Transistor (MOSFET), or may be others such as a semiconductor switch or a MEMS switch. These switches are miniaturized and light in weight as compared to a mechanical switch, and thus are advantageously used in miniaturizing and weight lightening of the force detection device 1. Hereinafter, as a representative example, a case of using the MOSFET as the switching element 903 will be described. As illustrated in FIG. 3, these switches are mounted on the conversion output circuit 90c or the conversion output circuits 90a and 90b, but can be alternatively mounted on the AD converter 401.

The switching element 903 has a drain electrode, a source electrode, and a gate electrode. One of the drain electrode or the source electrode of the switching element 903 is connected to the first input terminal of the operational amplifier 901, and the other of the drain electrode or the source electrode is connected to the output terminal of the operational amplifier 901. In addition, the gate electrode of the switching element 903 is connected to the drive circuit (not illustrated).

The same drive circuit may be connected to or respectively different drive circuits may be connected to the switching element 903 of the respective conversion output circuits 90a, 90b, and 90c. All synchronized ON/OFF signals are input from the drive circuit to each switching element 903. This synchronizes operations of the switching element 903 of the respective conversion output circuits 90a, 90b, and 90c. That is, the respective conversion output circuits 90a, 90b, and 90c have a coincident ON/OFF timing of the switching element 903.

Next, the external force detection circuit 40 included in the digital circuit board 5 will be described in detail.

### External Force Detection Circuit

The external force detection circuit 40 has a function of detecting the applied external force, based on the voltages Vy1, Vy2, Vy3, and Vy4 output from each conversion output circuit 90a, the voltages Vz1, Vz2, Vz3, and Vz4 output from each conversion output circuit 90b, and the voltages Vx1, Vx2, Vx3, and Vx4 output from each conversion output circuit 90c.

The external force detection circuit 40 has the AD converter 401 connected to the conversion output circuits (conversion circuits) 90a, 90b, and 90c, and the calculation unit (calculation circuit) 402 connected to the AD converter 401.

The AD converter 401 has a function of converting an analog signal into a digital signal for the voltages Vx1, Vy1, Vz1, Vx2, Vy2, Vz2, Vx3, Vy3, Vz3, Vx4, Vy4, and Vz4. The voltages Vx1, Vy1, Vz1, Vx2, Vy2, Vz2, Vx3, Vy3, Vz3, Vx4, Vy4, and Vz4 which are digitally converted by the AD converter 401 are input to the calculation unit 402.

For example, the calculation unit 402 performs each correction processing for eliminating a difference in sensitivity among the respective conversion output circuits 90a, 90b, and 90c on the digitally converted voltages Vx, Vy, and Vz. Then, the calculation unit 402 outputs three signals proportional to the accumulation amount of the charges Qx, Qy, and Qz output from the charge output element 10.

### Force Detection in α Axis, β Axis, and γ Axis Directions (Force Detection Method)

As described above, each charge output element 10 is in an installed state where the stacked direction LD and the pinching direction SD are in parallel with the first base unit 2 (bottom plate 22) and are orthogonal to the normal line NL₂ of the upper surface 321 (refer to FIG. 1).

Then, a force F_{A} in the α axis direction, a force F_{B} in the β axis direction, and a force F_{C} in the γ axis direction can be expressed by the following Expressions (1), (2), and (3). In Expressions (1) to (3), “fx₁₋₁” represents a force applied in the x axis direction of the first sensor 12 (first detection plate) of the sensor device 6A, that is, a force obtained from the charge Qx1 (first output), and “fx₁₋₂” represents a force applied in the x axis direction of the third sensor 14 (second detection plate), that is, a force obtained from the charge Qy1 (second output). In addition, “fx₂₋₂” represents a force applied in the x axis direction of the first sensor 12 (first detection plate) of the sensor device 6B, that is, a force obtained from the charge Qx2 (third output), and “fx₂₋₂” represents a force applied in the x axis direction of the third sensor 14 (second detection plate), that is, a force obtained from the charge Qy2 (fourth output).

F_{A}=fx₁₋₁·cos η−cos ε—fx₁₋₂·sin η·cos ε−fx₂₋₁·cos η·cos ε+fx₂₋₂·sin η·cos ε (1)

F_{B}=−fx₁₋₁·cos η·sin ε+fx₁₋₂·sin η·sin ε−fx₂₋₁·cos η·sin ε+fx₂₋₂·sin η·sin ε (2)

F_{C}=−fx₁₋₁·sin η−fx₁₋₂−cos η−fx₂₋₁·sin η−fx₂₋₂−cos η (3)

For example, in a case of the force detection device 1 having the configuration illustrated in FIGS. 1 and 2, ε is 45°, and η is 0°. If ε in Expressions (1) to (3) is substituted with 45° and η is substituted with 0°, the forces F_{A} to F_{C} are respectively expressed as follows.

F_{A}=fx₁₋₁/√2−fx₂₋₁/√2

F_{B}=−fx₁₋₁/√2−fx₂₋₁/√2

F_{C}=−fx₁₋₂−fx₂₋₂

As described above, when detecting the forces F_{A} to F_{C}, the force detection device 1 can perform the detection without using the second sensor 13 (charge Qz) which is likely to receive influence resulting from temperature fluctuations, that is, which is likely to include noise. Therefore, the force detection device 1 is allowed to be a device which is less likely to receive the influence resulting from the temperature fluctuations. For example, as compared to the force detection device in the related art, the influence is reduced to one-twentieth or smaller. This enables the force detection device 1 to accurately and stably detect the forces F_{A} to F_{C} under the environment of severe temperature fluctuations.

In the embodiment, all of the translational forces F_{A} to F_{C} and rotational forces M_{A} to M_{C} of the force detection device 1 are calculated, based on the charge output from each charge output element 10. In addition, in the embodiment, four charge output elements 10 are provided. However, as long as at least three charge output elements 10 are provided, the rotational forces M_{A} to M_{C} can be calculated.

In the force detection device 1 having this configuration, the total weight becomes lighter than 1 kg. In this manner, it is possible to decrease the load acting on a wrist to which the weight of the force detection device 1 is attached, and it is possible to minimize capacity of an actuator for driving the wrist. Accordingly, it is possible to design the miniaturized wrist. Furthermore, the weight of the force detection device 1 is lighter than 20% of the maximum capacity which can be conveyed by a robot arm. This can easily control the robot arm to which the weight of the force detection device 1 is attached.

The force detection device 1 as described above further includes a sealing ring (annular sealing member) 9 disposed by coming into contact (close contact) with a portion between the first base unit 2 and the second base unit 3. The above-described accommodation space is sealed with this sealing ring 9 in an air-tight (liquid-tight) manner. Thus, it is possible to prevent foreign materials such as dust and moisture from entering the inside of the force detection device 1. Accordingly, it is possible to prevent leakage of the charge output from each sensor device 6.

As illustrated in FIGS. 1 and 7, the first base unit 2 has a peripheral wall 25 which is erected upward from the bottom plate 22. The peripheral wall 25 is disposed along an outer edge portion of the bottom plate 22, and has a rectangular and cylindrical shape.

In contrast, the second base unit 3 has a protruding portion 35 which protrudes downward from the side wall 33. The protruding portion 35 is disposed along an inner edge portion of the side wall 33, and has a rectangular and cylindrical shape.

In a state where the force detection device 1 is assembled (hereinafter, referred to as an “assemble state of the force detection device 1”), as illustrated in FIG. 7, the protruding portion 35 is located inside the peripheral wall 25 of the first base unit 2. In addition, a size of an outer shape (region defined by an outer peripheral edge) of the protruding portion 35 is set to be smaller than a size of an inner shape (region defined by an inner peripheral edge) of the peripheral wall 25. In this manner, the protruding portion 35 (portion of the second base unit 3) and the peripheral wall 25 (portion of the first base unit 2) overlap each other over the whole periphery when viewed from the side of the force detection device 1 (in the direction orthogonal to the γ axis), and a gap 29 is formed between the protruding portion 35 and the peripheral wall 25.

In a portion where the protruding portion 35 and the peripheral wall 25 overlap each other, on a surface (second opposing surface) 351 facing an inner surface (first opposing surface) 251 of the peripheral wall 25 of the protruding portion 35, a groove 37 is formed along a peripheral direction thereof.

A vertical cross-sectional shape of the groove 37 is an oblong shape (rectangular shape) in the illustrated configuration, but is not limited thereto. For example, the shape may be a polygonal shape other than the oblong shape or a semicircular shape.

The sealing ring 9 configured to have an annular member having elasticity is disposed inside the groove 37 by means of fitting, for example. The sealing ring 9 has a cylindrical first section 91 extending along the γ axis direction and a rib-shaped second section 92 protruding outward from an intermediate portion in the γ axis direction of the first section 91, and a vertical cross-sectional shape thereof is a substantially T-shape.

The sealing ring 9 is a member in which the Young's modulus of the sealing ring 9 is higher than the Young's modulus of the protruding portion 35 (second base unit 3) and the Young's modulus of the peripheral wall 25 (first base unit 2). A configuration material of the sealing ring 9 is not particularly limited, but may include polyester-based resins such as polyvinyl chloride, polyethylene, polypropylene, polybutylene terephthalate, various resin materials such as polyurethane resins, various elastomers such as polyurethane-based thermoplastic elastomers, polyester-based thermoplastic elastomers, silicone rubber, and latex rubber. Among these materials, it is possible to use one material alone, or to use two or more materials in combination.

The first section 91 is in contact with the protruding portion 35 (second base unit 3) inside the groove 37, and the second section 92 is in contact with the first opposing surface 251 of the peripheral wall 25 (first base unit 2) in an end portion opposite to the first section 91.

The sealing ring 9 having the above-described configuration is configured so that an area in contact with the peripheral wall 25 (first base unit) is smaller than an area in contact with the protruding portion 35 (second base unit). Therefore, since the area in contact with the peripheral wall 25 is relatively small, the sealing ring 9 can prevent an unnecessary increase in a friction force generated between the sealing ring 9 and the peripheral wall 25. In contrast, since the area in contact with the protruding portion 35 becomes sufficiently large in the sealing ring 9, a strong friction force (including a fitting force) is generated therebetween.

As illustrated in FIG. 7, the thickness (length extending along the γ axis direction) of the second section 92 of the sealing ring 9 is thinner (shorter) than the thickness of the first section 91. This allows the second section 92 to have sufficiently high elasticity.

Furthermore, in the embodiment, the length of the portion protruding from the groove 37 of the second section 92 is set to be longer than the width (length in a direction along the αβ plane) of the gap 29 formed between the protruding portion 35 and the peripheral wall 25 in the assembled state of the force detection device 1.

For this reason, when the first base unit 2 and the second base unit 3 are assembled together, the second section 92 of the sealing ring 9 comes into contact with the peripheral wall 25, thereby deforming the sealing ring 9 upward so as to be bent. Accordingly, it is possible to reliably insert the protruding portion 35 into the peripheral wall 25, that is, it is possible to reliably bring the force detection device 1 into the assemble state. At this time, since the friction force between the second section 92 and the peripheral wall 25 is sufficiently weak, it is possible to easily insert the protruding portion 35 into the peripheral wall 25. In contrast, since the friction force (including the fitting force) between the first section 91 and the protruding portion 35 is sufficiently strong, it is possible to reliably prevent the sealing ring 9 from being separated from the groove 37, when the first base unit 2 and the second base unit 3 are assembled together.

In a state where the first base unit 2 and the second base unit 3 have been assembled together, an elastic force of the sealing ring 9 causes the first section 91 to closely adhere to (come into close contact with) the protruding portion 35 in the groove 37, and causes the second section 92 to closely adhere to the first opposing surface 251 of the peripheral wall 25. Therefore, in the assembled state of the force detection device 1, the accommodation space is reliably sealed with the sealing ring 9.

In the sealing ring 9 remaining in a natural state (state before being compressed), the second section 92 is substantially orthogonal to the first section 91. However, in the assembled state of the force detection device 1, due to the friction force with the first opposing surface 251 of the peripheral wall 25, an end portion of the second section 92 which is opposite to the first section 91 is slightly deflected so as to be located on the further upper side than an end portion of the first section 91 side.

The following advantageous effects can be obtained by this configuration. First, since the sealing ring 9 has an annular shape, even when the sealing ring 9 is deformed due to thermal expansion, the deformation (thermal expansion) is substantially uniform in the peripheral direction (that is, has a symmetry). Therefore, the output from each sensor device 6 which results from the thermal expansion of the sealing ring in the αβ plane direction is offset, and does not significantly affect the detection sensitivity of the force detection device 1. In addition, the sealing ring 9 is disposed between the first base unit 2 and the second base unit 3 in a direction substantially perpendicular to the γ axis direction (second direction). In other words, the sealing ring 9 is not disposed between the first base unit 2 and the second base unit 3 in the γ axis direction. Therefore, even when the sealing ring 9 is deformed due to the thermal expansion, stress is less likely to be generated in a direction where the first base unit 2 and the second base unit 3 are separated from each other. As a result, the sealing ring 9 is less likely to significantly affect the detection sensitivity in the γ axis direction (first direction) of the force detection device 1.

In contrast, in a force detection device (that is, corresponding to the force detection device in the related art) in which the sealing ring 9 is disposed between the first base unit 2 and the second base unit 3 in the γ axis direction (for example, in the gap 28 in FIG. 7), the output from each sensor device 6 which results from the thermal expansion of the sealing ring 9 in the αβ plane direction is offset for the above-described reason, and does not significantly affects the detection sensitivity. However, the stress acting in the direction where the first base unit 2 and the second base unit 3 are separated from each other is generated in the γ axis direction, and is detected as unnecessary stress.

The influence on the detection sensitivity in the γ-axis direction of the force detection device 1 which is exerted by thermal expansion of the sealing ring 9 as described above will be described, based on a result of the examination performed by the present inventors.

As illustrated in FIGS. 8A and 8B, in the examination, a force detection device 1A (refer to FIG. 8A) in a case where the sealing ring 9 is arranged between the first base unit 2 and the second base unit 3 in the γ axis direction, and a force detection device 1B (refer to FIG. 8B) in a case where the sealing ring 9 is arranged between the first base unit 2 and the second base unit 3 in the direction substantially perpendicular to the γ axis direction are prepared. In the examination, the sealing ring 9 whose vertical cross-sectional shape is a rectangular shape is used. Then, the outputs of the force detection device 1A and the force detection device 1B in the γ axis direction when the temperature of the external environment is changed from 25° C. to 26° C. are respectively detected.

As a result, in the case of the force detection device 1A, the output in the γ axis direction is 3.4 kg/° C. In contrast, in the case of the force detection device 1B, the output in the γ axis direction is −71.8 kg/° C. For this reason, it is understood that the output of the force detection device 1A in the γ axis direction is smaller than the output of the force detection device 1B in the γ axis direction by approximately 21 times. In this manner, it is understood that it is possible to reduce the influence on the detection sensitivity in the γ axis direction by disposing the sealing ring 9 between the first base unit 2 and the second base unit 3 in the direction substantially perpendicular to the γ axis direction.

With regard to the detection sensitivity in the αβ plane direction, there is no significant difference between the force detection device 1A and the force detection device 1B.

The sealing ring 9 as described above is configured so that the first section 91 and the second section 92 are formed integrally, but may be obtained by separately forming the first section 91 and the second section 92, and by bonding and fusing both of these using an adhesive. However, in a viewpoint that mechanical strength of a boundary portion between the first section 91 and the second section 92 can be higher, it is preferable that the first section 91 and the second section 92 are formed integrally.

As described above, in the assembled state of the force detection device 1, the sealing ring 9 is compressed between the peripheral wall 25 and the side wall 33. However, a degree of the compressing force (wrapping force) is not particularly limited. The wrapping force is set depending on the elastic force of the sealing ring 9, the shape of the sealing ring 9, the width dimension of the gap 29 formed between the protruding portion 35 and the peripheral wall 25 in the assembled state of the force detection device 1.

In the embodiment, the sealing ring 9 is disposed so that the first section 91 comes into contact with the protruding portion 35 and the second section 92 comes into contact with the peripheral wall 25. However, the sealing ring 9 may be disposed so that the first section 91 comes into contact with the peripheral wall 25 and the second section 92 comes into contact with the protruding portion 35.

In the embodiment, the groove 37 is disposed in the protruding portion 35, but the groove 37 may not be disposed in the protruding portion 35. That is, the second opposing surface 351 of the protruding portion 35 may be configured to have a flat surface over the whole periphery. In addition, in a case where the first section 91 is disposed so as to come into contact with the peripheral wall 25, a groove which is the same as the groove 37 may be disposed on the first opposing surface 251 of the peripheral wall 25, for example.

In the embodiment, the sealing ring 9 is disposed so that the width direction (direction from one to the other of the outer edge and the inner edge) is substantially perpendicular to the γ axis direction, but may be disposed so that the width direction is tilted with respect to the γ axis direction (is not in parallel with the γ axis direction). This configuration can also achieve advantageous effects which are the same as those described above. An angle formed by the width direction of the sealing ring 9 and the γ axis direction is preferably 15° to 90°, more preferably 30° to 90°, and most preferably 45° to 90°.

The shape of the sealing ring 9 is not limited to the above-described shape, but can be alternatively a shape illustrated in FIGS. 9A to 9C.

The sealing ring 9 illustrated in FIG. 9A has the first section 91 having a cylindrical shape and the second section 92 having a rib shape which protrudes outward from the lower end portion of the first section 91 in the γ axis direction, and the vertical cross-sectional shape is a substantially L-shape.

The sealing ring 9 illustrated in FIG. 9B has the first section 91 having a cylindrical shape, the second section 92 having a rib shape which protrudes outward from the lower end portion of the first section 91 in the γ axis direction, and a third section 93 having a rib shape which protrudes outward from the upper end portion of the first section 91 in the γ axis direction. The vertical cross-sectional shape is a substantially U-shape.

The sealing ring 9 illustrated in FIG. 9C has the first section 91 located on the protruding portion 35 side and having a cylindrical shape, the third section 93 located on the peripheral wall 25 side and having a cylindrical shape, and the second section 92 having a rib shape connecting the lower end portions thereof to each other. The vertical cross-sectional shape is a substantially U-shape.

### Second Embodiment

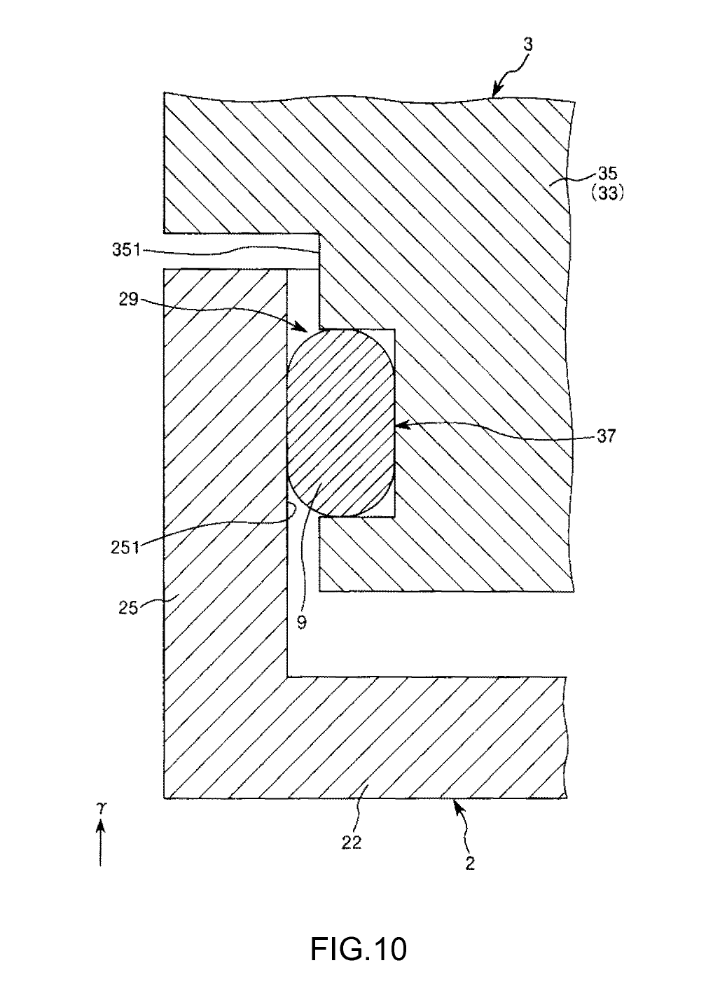

FIG. 10 is a cross-sectional view illustrating a second embodiment of the force detection device according to the invention. FIG. 10 illustrates a partial enlarged view of a sealing member and the vicinity which are included in a force detection device according to the second embodiment.

Hereinafter, the second embodiment of the invention will be described with reference to the drawing. Description will be made by focusing on points which are different from those in the above-described embodiment, and description of the same points will be omitted.

The second embodiment is the same as the first embodiment except that configurations of the sealing ring (sealing member) are different from each other.

Specifically, the sealing ring 9 illustrated in FIG. 10 is configured so that the vertical cross-sectional shape is a corner-rounded rectangular shape (substantially elliptical shape). The sealing ring 9 having this configuration can also achieve operations and advantageous effects which are the same as those of the sealing ring 9 illustrated in FIG. 7.

The sealing ring 9 having the configuration illustrated in FIG. 10 has no sudden shape change in the γ axis direction of the vertical cross section. Therefore, even after the sealing ring 9 is repeatedly thermally deformed, the sealing ring 9 is hardly damaged. In addition, in case of the sealing ring 9 having the configuration illustrated in FIG. 10, the sealing ring 9 can hold the elasticity as a whole, thereby enabling the accommodation space to be reliably sealed with the sealing ring 9.

The shape of the sealing ring 9 is not limited to the above-described shape, but the vertical cross-sectional shape may be alternatively a circular shape such as an oval shape and a perfect circle shape, or a polygonal shape such as a triangular shape, a rectangular shape, and a rhombic shape.

### 2. Single-Arm Robot

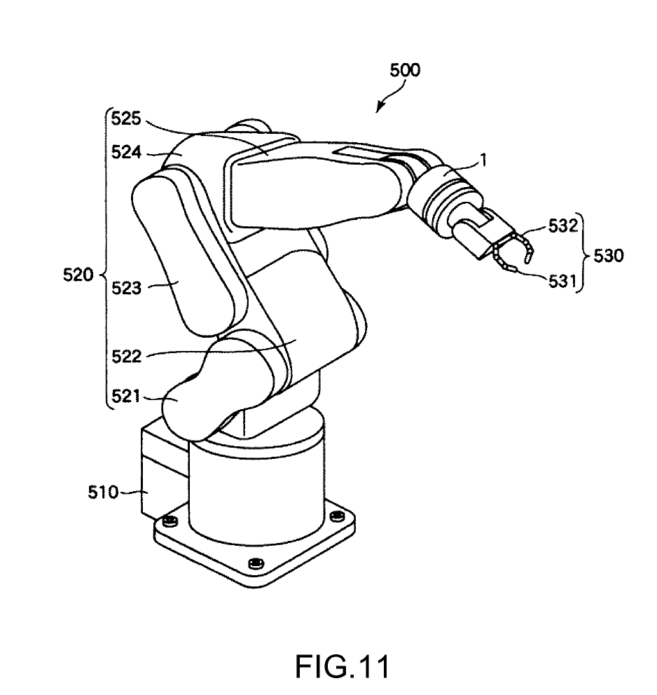

Next, a single-arm robot as an embodiment of a robot according to the invention will be described with reference to FIG. 11.

FIG. 11 is a view illustrating an example of the single-arm robot using the force detection device according to the invention. A single-arm robot 500 in FIG. 11 has a mount base 510, an arm 520, an end effector 530 disposed on a distal end side of the arm 520, and the force detection device 1 disposed between the arm 520 and the end effector 530. The force detection device 1 which is the same as those in the above-described respective embodiments is employed.

The mount base 510 has a function of accommodating an actuator (not illustrated) which generates power for rotating the arm 520 and a control unit (not illustrated) which controls the actuator. In addition, for example, the mount base 510 is fixed onto a floor, a wall, a ceiling, and a movable carriage.

The arm 520 has a first arm element 521, a second arm element 522, a third arm element 523, a fourth arm element 524, and a fifth arm element 525, and is configured so that the adjacent arm elements are rotatably connected to each other. The control unit controls the arm 520 to be driven through complex rotation or flexion around a connection portion of each arm element.

The end effector 530 has a function of gripping an object. The end effector 530 has a first finger 531 and a second finger 532. The arm 520 is driven so that the end effector 530 reaches a predetermined operation position, and then the separation distance between the first finger 531 and the second finger 532 is adjusted, thereby enabling the object to be gripped.

Here, the end effector 530 serves as a hand, but the invention is not limited thereto. For example, another example of the end effector includes component inspecting equipment, component conveying equipment, component processing equipment, component assembling equipment, and measurement instruments. This is similarly applied to the end effector according to other embodiments.

The force detection device 1 has a function of detecting an external force applied to the end effector 530. The force detected by the force detection device 1 is fed back to the control unit of the mount base 510, thereby enabling the single-arm robot 500 to carry out more precise work. In addition, the force detected by the force detection device 1 enables the single-arm robot 500 to detect whether or not the end effector 530 touches an obstacle. Therefore, it is possible to easily perform an obstacle avoidance operation and a damage avoidance operation for an object which are difficult jobs according to the position control in the related art, thereby enabling the single-arm robot 500 to carry out work more safely.

In the illustrated configuration, the arm 520 is configured to have five arm elements in total, but the invention is not limited thereto. A case where the arm. 520 is configured to have one arm element, a case where the arm 520 is configured to have two to four arm elements, and a case where the arm 520 is configured to have six or more arm elements are also included in the scope of the invention.

### 3. Multiple-Arm Robot

A multiple-arm robot as an embodiment of the robot according to the invention will be described.

The multiple-arm robot has two arms and a force detection device disposed between each arm and an end effector. The force detection device which is the same as those in the above-described respective embodiments is employed.

Two arms in total are provided, but the invention is not limited thereto. A case where the multiple-arm robot has three or more arms is also included in the scope of the invention.

### 4. Electronic Component Inspection Apparatus and Electronic Component Conveyance Apparatus

An electronic component inspection apparatus (electronic component detection apparatus) and an electronic component conveyance apparatus which include the force detection device according to the invention will be described.

The electronic component conveyance apparatus includes a gripping unit for gripping electronic components and the force detection device for detecting a force applied to the gripping unit. The force detection device which is the same as those in the above-described respective embodiments is employed.

Then, the electronic component inspection apparatus has the electronic component conveyance apparatus incorporated therein, and includes an inspection unit for inspecting the electronic components conveyed by the electronic component conveyance apparatus.

### 5. Component Processing Apparatus

An embodiment of a component processing apparatus will be described.

The component processing apparatus includes a tool displacement unit for displacing a tool and the force detection device 1 connected to the tool displacement unit. The force detection device which is the same as those in the above-described respective embodiments is employed.

Hitherto, the force detection device and the robot according to the invention have been described with reference to the illustrated embodiments. However, the invention is not limited thereto. Each element configuring the force detection device and the robot can be replaced with any desired configuration element which can show the same function. Alternatively, any desired configuration element may be added to the invention.

In the force detection device and the robot according to the invention, any desired two or more configurations (characteristics) from the above-described respective embodiments may be adopted in combination.

In the force detection device according to the invention, the charge output element is disposed at four locations, but the number of the charge output elements is not limited thereto. For example, one, two, three, five, or more charge output elements may be provided.

For example, instead of the pressurization bolt, the invention may employ those which do not have a function of applying pressurization to an element, or may employ a fixing method other than the method of using the bolt.

As long as the arm is provided, the robot according to the invention is not limited to the arm-type robot (robot arm), but may be other-type robots such as scalar robots and legged walking (travelling) robots.

Without being limited to the robot, the electronic component conveyance apparatus, the electronic component inspection apparatus, the component processing apparatus, and the movable body, the force detection device according to the invention can also be applied to other apparatuses, for example, other conveyance apparatuses, other inspection apparatuses, vibrometers, accelerometers, gravimeters, dynamometers, seismometers, measurement apparatuses such as inclinometers, and input apparatuses.

The entire disclosure of Japanese Patent Application No. 2014-057663, filed Mar. 20, 2014 is expressly incorporated by reference herein.

What is claimed is:

1. A force detection device comprising:
a first base unit;
a second base unit that is arranged along a first direction with respect to the first base unit;
a sealing member that is disposed in a section where the first base unit and the second base unit overlap each other when viewed in a second direction orthogonal to the first direction, and that forms a closed space with the first base unit and the second base unit; and
a piezoelectric element that is disposed inside the closed space,
wherein the Young's modulus of the sealing member is higher than the Young's modulus of the first base unit and the Young's modulus of the second base unit.

2. The force detection device according to claim 1,
wherein the sealing member is configured so that an area in contact with the first base unit is smaller than an area in contact with the second base unit.

3. The force detection device according to claim 1,
wherein the sealing member has a first section and a second section whose length along the first direction is shorter than the length of the first portion.

4. The force detection device according to claim 1,
wherein a portion of the first base unit overlaps a portion of the second base unit over an entire circumference of the second base unit when viewed in the second direction.

5. The force detection device according to claim 1,
wherein the sealing member has an annular shape.

6. The force detection device according to claim 1,
wherein the piezoelectric element includes a quartz crystal.

7. The force detection device according to claim 1,
wherein the piezoelectric element is provided at multiple locations.

8. A robot comprising:
an arm;
an end effector that is disposed in the arm; and
a force detection device that is disposed between the arm and the end effector, and that detects an external force applied to the end effector,
wherein the force detection device includes a first base unit, a second base unit that is arranged along a first direction with respect to the first base unit, a sealing member that is disposed in a section where the first base unit and the second base unit overlap each other when viewed in a second direction orthogonal to the first direction, and that forms a closed space with the first base unit and the second base unit, and a piezoelectric element that is disposed inside the closed space, and
wherein the Young's modulus of the sealing member is higher than the Young's modulus of the first base unit and the Young's modulus of the second base unit.
